(19) United States
(12) Patent Application Publication
(10) Pub. No.: US 2026/0298000 A1
(43) Pub. Date: Oct. 1, 2026

(54) ADJUSTABLE HINGE ASSEMBLY

(71) Applicant: WHIRLPOOL CORPORATION, BENTON HARBOR, MI (US)

(72) Inventors: Rafael S. Chaves, Joinville (BR); Ryan C. Chisek, Watervliet, MI (US); Marcel B. Lessa, Watervliet, MI (US)

(73) Assignee: WHIRLPOOL CORPORATION, BENTON HARBOR, MI (US)

(21) Appl. No.: 19/090,858

(22) Filed: Mar. 26, 2025

(51) Int. Cl. E05D 7/04; E05D 7/081; F25D 23/02

(52) U.S. Cl. CPC E05D 7/04; E05D 7/081; F25D 23/028; E05Y 2900/31; F25D 2323/024

(57) ABSTRACT

A hinge bracket assembly includes an upper hinge bracket coupled to an upper hinge of an appliance and a first mounting location proximate a top side of an insulated door, wherein the upper hinge bracket is adjustable relative to the insulated door, and a lower hinge bracket coupled to a lower hinge of the appliance and a second mounting location proximate a bottom side of the insulated door, wherein the lower hinge bracket is adjustable relative to the insulated door, wherein the upper hinge bracket is configured to couple to the lower hinge and the second mounting location, and wherein the lower hinge bracket is configured to couple to the upper hinge and the first mounting location.

### FIELD OF THE DISCLOSURE

The present disclosure generally relates to a hinge assembly for an appliance, and more specifically, to an adjustable door hinge assembly for an appliance.

### SUMMARY OF THE DISCLOSURE

According to one aspect of the present disclosure, a refrigerator includes a cabinet defining an upper side and a lower side, an upper hinge coupled to the cabinet proximate the upper side, a lower hinge coupled to the cabinet proximate the lower side, and a door defining a top side, a bottom side, a first side, and a second side, wherein the first side and the second side extend between the top side and the bottom side of the door. An upper elongate bracket extends along the top side of the door and a lower elongate bracket extending along the bottom side of the door, wherein the upper elongate bracket and the lower elongate bracket each define a plurality of mounting locations, wherein the plurality of mounting locations of the upper elongate bracket includes a first mounting location, and wherein the plurality of mounting locations of the lower elongate bracket includes a second mounting location. An upper hinge bracket is coupled to the upper hinge and the first mounting location, wherein the upper hinge bracket is adjustable relative to the upper elongate bracket in at least two dimensions, and a lower hinge bracket is coupled to the lower hinge and the second mounting location, wherein the lower hinge bracket is adjustable relative to the lower elongate bracket in at least two dimensions.

According to another aspect of the present disclosure, a hinge bracket assembly for an insulated appliance includes a door defining a top side, a bottom side, a first side, and a second side, wherein the first side and the second side extend between the top side and the bottom side. A plurality of mounting locations is provided proximate each of the top side and the bottom side, the plurality of mounting locations including a first mounting location proximate the top side. A first hinge bracket is adjustably coupled to the first mounting location, wherein the first hinge bracket is configured to adjustably couple to each of the plurality of mounting locations, and wherein the first hinge bracket is adjustable relative to the first mounting location in at least two dimensions.

According to yet another aspect of the present disclosure, a hinge bracket assembly includes an upper hinge bracket coupled to an upper hinge of an appliance and a first mounting location proximate a top side of an insulated door, wherein the upper hinge bracket is adjustable relative to the insulated door, and a lower hinge bracket coupled to a lower hinge of the appliance and a second mounting location proximate a bottom side of the insulated door, wherein the lower hinge bracket is adjustable relative to the insulated door, wherein the upper hinge bracket is configured to couple to the lower hinge and the second mounting location, and wherein the lower hinge bracket is configured to couple to the upper hinge and the first mounting location.

Misalignments between a door and a cabinet of a refrigerator can result in undesirable heat transfer between an internal refrigerator compartment and an environment outside of the refrigerator. Variability in tolerance of refrigerator components resulting from manufacturing processes can lead to misalignments between the door and the cabinet. It is therefore desirable to introduce adjustability into the assembly of refrigerators, and specifically, during the coupling of the door and the cabinet. The hinge bracket assembly shown and described herein enables adjustment of the alignment between the door and the cabinet in multiple dimensions to account for misalignments that may otherwise result during assembly of the refrigerator. The hinge bracket assembly additionally provides a modular aspect that enables multiple configurations of the refrigerator to be achieved. For example, a refrigerator equipped with the hinge bracket assembly includes interchangeable hinge brackets that may be coupled to a variety of mounting locations on the door such that the door can be conveniently configured to open from a first side of the cabinet or a second side of the cabinet.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a side front perspective view of a refrigerator having a cabinet and a door pivotally coupled to the cabinet via an adjustable hinge assembly;

FIG. 2 is an enlarged partial perspective view of an upper hinge coupled to the cabinet and an upper hinge bracket that is coupled to the door at a first mounting position;

FIG. 3 is a front elevational view of the door equipped with the upper hinge bracket at a third mounting location on the door and a lower hinge bracket at a fourth mounting location on the door;

FIG. 4A is an enlarged top perspective view of the upper hinge bracket coupled to the third mounting location via an engagement assembly in an engaged position;

FIG. 4B is an enlarged top perspective view of the upper hinge bracket disposed at the third mounting location, where the engagement assembly is in a disengaged position; and

FIG. 5 is a detailed top view of the upper hinge bracket disposed at the third mounting location, where the engagement assembly is in the disengaged position.

The components in the figures are not necessarily to scale, emphasis instead being placed upon illustrating the principles described herein.

### DETAILED DESCRIPTION

The present illustrated embodiments reside primarily in combinations of method steps and apparatus components related to an adjustable hinge assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

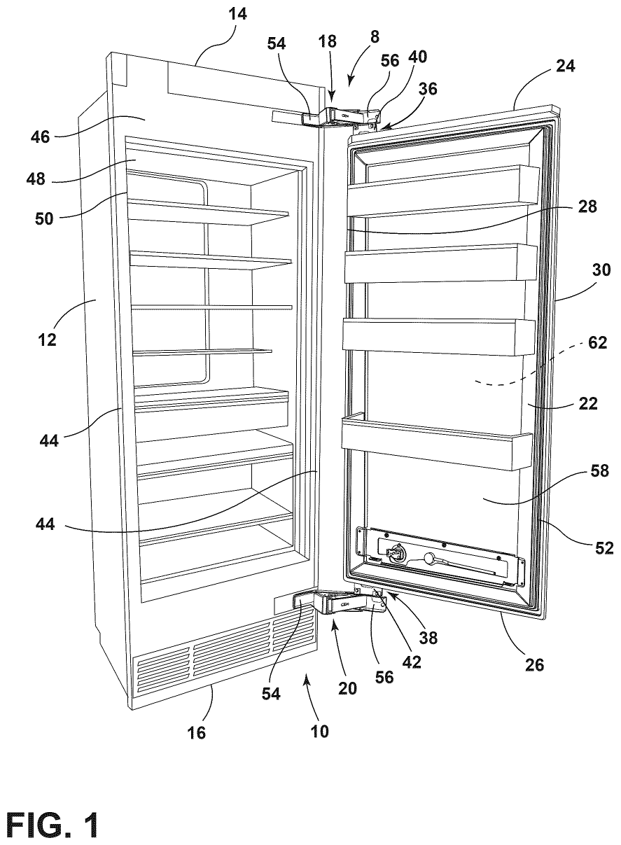

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

In this document, relational terms, such as first and second, top and bottom, and the like, are used solely to distinguish one entity or action from another entity or action, without necessarily requiring or implying any actual such relationship or order between such entities or actions. The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a.” does not, without more constraints, preclude the existence of additional identical elements in the process, method, article, or apparatus that comprises the element.

Referring to FIGS. 1-4B, a hinge bracket assembly 8 is incorporated into a refrigerator 10. The refrigerator 10 includes a cabinet 12 defining an upper side 14 and a lower side 16, an upper hinge 18 coupled to the cabinet 12 proximate the upper side 14, and a lower hinge 20 coupled to the cabinet 12 proximate the lower side 16. The refrigerator 10 further includes a door 22 defining a top side 24, a bottom side 26, a first side 28, and a second side 30, wherein the first and second sides 28, 30 extend between the top and bottom sides 24, 26 of the door 22. An upper elongate bracket 32 extends along the top side 24 of the door 22 and a lower elongate bracket 34 extends along the bottom side 26 of the door 22, and the upper and lower elongate brackets 32, 34 each define a plurality of mounting locations. The plurality of mounting locations of the upper elongate bracket 32 includes a first mounting location 36, and the plurality of mounting locations of the lower elongate bracket 34 includes a second mounting location 38. An upper hinge bracket 40 is coupled to the upper hinge 18 and the first mounting location 36, where the upper hinge bracket 40 is adjustable relative to the upper elongate bracket 32 in at least two dimensions. A lower hinge bracket 42 is coupled to the lower hinge 20 and the second mounting location 38, where the lower hinge bracket 42 is adjustable relative to the lower elongate bracket 34 in at least two dimensions.

Referring to FIG. 1, the refrigerator 10 includes the cabinet 12 and the door 22. The cabinet 12 defines the upper side 14, the lower side 16, and a pair of opposing intermediate sides 44 extending between the upper and lower sides 14, 16. The cabinet 12 also defines a front face 46 and an internal compartment 48 that is recessed relative to the front face 46. The front face 46 defines an opening 50 providing access to the internal compartment 48. The upper and lower hinges 18, 20 are coupled to the cabinet 12 proximate the upper and lower sides 14, 16, respectively. The door 22 is coupled to each of the upper and lower hinges 18, 20 and is configured to selectively cover the opening 50. The door 22 includes a peripheral gasket 52. When the door 22 covers the opening 50, the gasket 52 and the front face 46 form a sealed connection, and heat and fluid transfer between the internal compartment 48 and an environment external to the refrigerator 10 is inhibited. In some instances, each of the upper and lower hinges 18, 20 may be coupled to the cabinet 12 at a location other than the front face 46, such as the upper side 14, the lower side 16, or one of the intermediate sides 44.

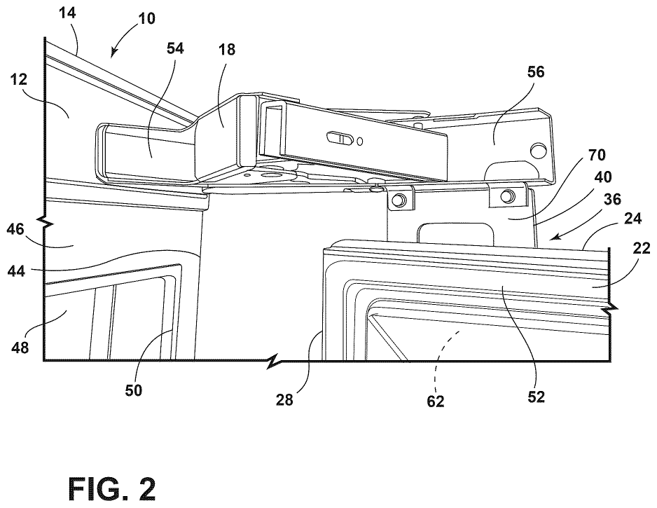

With reference to FIGS. 1 and 2, each of the illustrated upper and lower hinges 18, 20 includes a first leg 54 and a second leg 56, where the second leg 56 is pivotal relative to the first leg 54. The first legs 54 of the upper and lower hinges 18, 20 are coupled to the front face 46 of the cabinet 12 and the second legs 56 of the upper and lower hinges 18, 20 are coupled to the upper and lower hinge brackets 40, 42, respectively. The first leg 54 of the upper hinge 18 is disposed on the front face 46 of the cabinet 12 proximate the upper side 14, and the first leg 54 of the lower hinge 20 is disposed on the front face 46 of the cabinet 12 proximate the lower side 16. The second leg 56 of the upper hinge 18 is coupled to the upper hinge bracket 40 proximate the top side 24 of the door 22, and the second leg 56 of the lower hinge 20 is coupled to the lower hinge bracket 42 proximate the bottom side 26 of the door 22. Accordingly, the door 22 is pivotal between an open position and a closed position. In the open position, the internal compartment 48 of the cabinet 12 is accessible through the opening 50. In the closed position, the door 22 covers the opening 50. As illustrated in FIGS. 1 and 2, the second leg 56 of the upper and lower hinges 18, 20 are coupled to the upper and lower hinge brackets 40, 42, respectively, via fasteners. The fasteners may be rivets, screws, bolts, nuts, bolt-and-nut combinations, and/or other fasteners. It is also contemplated that the upper and lower hinges 18, 20 or a component thereof may be integrally formed with the upper and lower hinge brackets 40, 42, respectively. Notably, the first and second hinges 18, 20 may be alternatively constructed.

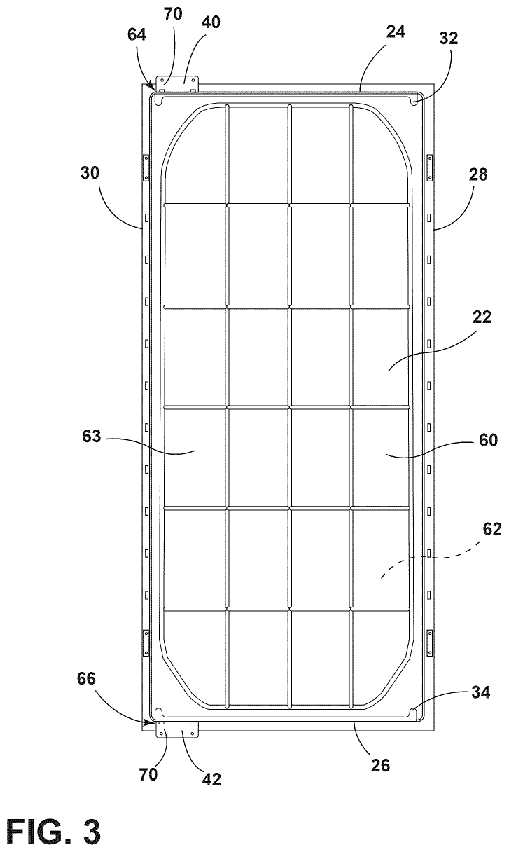

With reference to FIGS. 1-3, the door 22 includes an inner liner 58 (FIG. 1) and an outer wrapper 60 (FIG. 3), where the outer wrapper 60 is configured to partially wrap the top and bottom sides 24, 26 of the door 22. Together, the inner liner 58 and the outer wrapper 60 at least partially define an interior space 62 configured to receive insulative material and sustain a state of low pressure relative to ambient air outside of the refrigerator 10. The upper and lower elongate brackets 32, 34 are coupled to the outer wrapper 60 so as to distribute the stress imposed on the outer wrapper 60 at the top and bottom sides 24, 26 of the door 22, respectively. The upper elongate bracket 32 extends along the top side 24 of the door 22 and the lower elongate bracket 34 extends along the bottom side 26 of the door 22. Furthermore, the upper and lower elongate brackets 32, 34 each extend onto an outer side 63 of the door 22. Each of the upper and lower elongate brackets 32, 34 provide one or more attachment points, such as the plurality of mounting locations, for refrigerator components. Generally, the upper and lower elongate brackets 32, 34 are welded to the outer wrapper 60 of the door 22 at the top and bottom sides 24, 26, respectively. Additionally or alternatively, the upper and lower elongate brackets 32, 34 may be coupled to the outer wrapper 60 of the door 22 with fasteners and/or adhesive material. In some instances, the upper and lower elongate brackets 32, 34 extend along the top and bottom sides 24, 26 of the door 22, respectively, and not the outer side 63 of the door 22. The door 22 may be uninsulated according to some aspects.

Each of the upper and lower elongate brackets 32, 34 define a plurality of mounting locations, each of which is configured to receive and secure one of the upper and lower hinge brackets 40, 42. In some instances, as seen in FIG. 1, the upper hinge bracket 40 is coupled to the first mounting location 36 at the top side 24 of the door 22 proximate the first side 28, and the lower hinge bracket 42 is coupled to the second mounting location 38 at the bottom side 26 of the door 22 proximate the first side 28. In another instance, as seen in FIG. 3, the upper hinge bracket 40 is coupled to a third mounting location 64 at the top side 24 of the door 22 proximate the second side 30, and the lower hinge bracket 42 is coupled to a fourth mounting location 66 at the bottom side 26 of the door 22 proximate the second side 30.

According to some aspects, each of the upper and lower elongate brackets 32, 34 may define additional mounting locations between the first and second sides 28, 30 of the door 22. Additionally or alternatively, the outer wrapper 60 of the door 22, the outer side 63 of the door 22, the inner liner 58 of the door 22, the first side 28 of the door 22, and/or the second side 30 of the door 22 may define one or more mounting locations. Accordingly, the upper and lower hinge brackets 40, 42 may be coupled directly to the door 22 and not the upper and lower elongate brackets 32, 34. Thus, the door 22 may be coupled to appliances having a variety of hinges, dimensions, and/or constructions. It follows that the door 22 may be configured to secure to appliances other than the refrigerator 10 without deviating from the current disclosure.

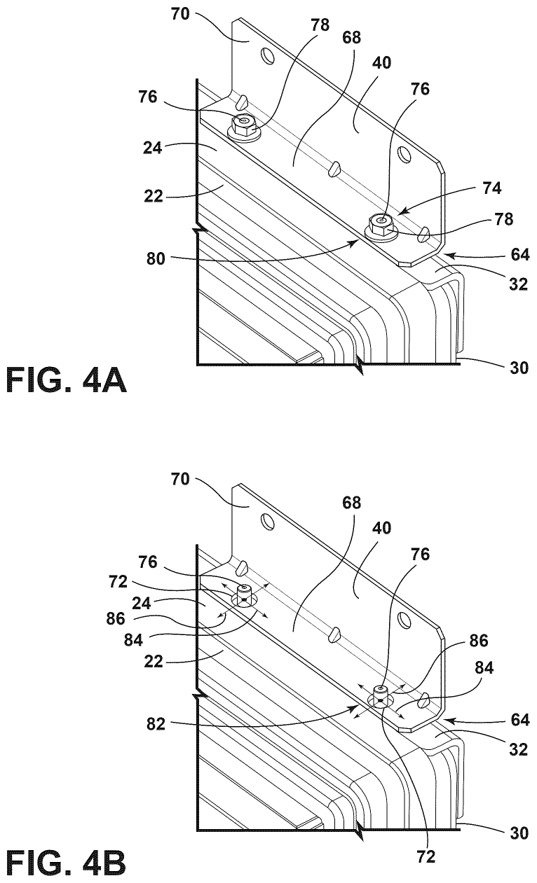

Referring to FIGS. 3-4B, the upper hinge bracket 40 is coupled to the third mounting location 64 defined by the upper elongate bracket 32 proximate the second side 30 of the door 22. The upper hinge bracket 40 includes a first member 68 extending along the top side 24 of the door 22 and a second member 70 extending vertically away from the top side 24 of the door 22. The second member 70 defines attachment points configured to be coupled to the second leg 56 of one of the upper and lower hinges 18, 20 (FIG. 1). The upper hinge bracket 40 also defines a uniform thickness and is generally made of a metallic material, yet the upper hinge bracket 40 may alternatively define a non-uniform thickness and be made of another rigid material. According to some aspects, the second member 70 extends substantially orthogonally from the first member 68. According to other aspects, the second member 70 may extend horizontally from the top side 24 of the door 22 so as to be coupled to a hinge having a different configuration. The first member 68 defines a plurality of apertures 72 extending vertically therethrough, where an engagement assembly 74 is configured to secure the upper hinge bracket 40 to the third mounting location 64 through the plurality of apertures 72. The lower hinge bracket 42 may have a construction that is identical or similar to the upper hinge bracket 40 and may be configured to couple to one of the plurality of mounting locations defined by the lower elongate bracket 34 via another engagement assembly 74.

The engagement assembly 74 includes a plurality of engagement features 76 and a plurality of fasteners 78, where each of the plurality of fasteners 78 is configured to couple to one of the plurality of engagement features 76. As illustrated in FIG. 4B, each of the plurality of engagement features 76 is a bolt that extends from the upper elongate bracket 32 at the third mounting location 64 and is received by one of the plurality of apertures 72 of the upper hinge bracket 40. As illustrated in FIG. 4A, each of the plurality of fasteners 78 is a nut that receives one of the plurality of engagement features 76. The plurality of fasteners 78 is configured to couple the first member 68 of the upper hinge bracket 40 to the upper elongate bracket 32 when coupled to the plurality of engagement features 76. Additional engagement features 76 may be provided at any combination of the plurality of mounting locations defined by the upper and lower elongate brackets 32, 34. Accordingly, additional engagement features 76 provided at the first mounting location 36 or another mounting location defined by the upper elongate bracket 32 may be received by the plurality of apertures 72 of the upper hinge bracket 40, and the plurality of fasteners 78, or additional fasteners 78, may receive the additional engagement features 76 and couple the upper hinge bracket 40 to the upper elongate bracket 32 when the plurality of apertures 72 is received by the additional engagement features 76. An additional engagement assembly 74 may also couple the lower hinge bracket 42 to any of the plurality of mounting locations defined by the lower elongate bracket 34 in a configuration that is identical or similar to the coupling of the upper hinge bracket 40 to the third mounting location 64 (FIG. 4A).

According to some aspects, the plurality of fasteners 78 of the engagement assembly 74 may be configured to couple to the engagement features 76 provided at any of the plurality of mounting locations defined by the upper and lower elongate brackets 32, 34. It is also contemplated that the upper hinge bracket 40 may be alternatively coupled to any one of the plurality of mounting locations defined by the lower elongate bracket 34 in a configuration that is identical or similar to the coupling of the upper hinge bracket 40 to the third mounting location 64 (FIG. 4A). Similarly, the lower hinge bracket 42 may be coupled to any one of the plurality of mounting locations defined by the upper elongate bracket 32 in a configuration that is identical or similar to the coupling of the upper hinge bracket 40 to the third mounting location 64 (FIG. 4A).

With further reference to FIGS. 3-4B, the plurality of engagement features 76 and the plurality of fasteners 78 may be threaded. The engagement assembly 74 may additionally or alternatively include other types of engagement features and/or fasteners. For example, at least one of the plurality of engagement features 76 may be a threaded cavity defined by the upper elongate bracket 32 or the lower elongate bracket 34, and at least one of the plurality of fasteners 78 may be a threaded bolt or screw configured to couple to the threaded cavity. It is also contemplated that the plurality of engagement features 76 may alternatively extend directly from the outer wrapper 60 or another location provided by the door 22.

The engagement assembly 74 illustrated in FIGS. 4A and 4B is operable between an engaged position 80 (FIG. 4A) and a disengaged position 82 (FIG. 4B). The engagement assembly 74 is in the engaged position 80 when the plurality of engagement features 76 are received by the plurality of apertures 72 of the upper hinge bracket 40 and the first member 68 of the upper hinge bracket 40 is secured against the upper elongate bracket 32 by the plurality of fasteners 78. The engagement assembly 74 is in the disengaged position 82 when the plurality of engagement features 76 are received by the plurality of apertures 72 of the upper hinge bracket 40 and the first member 68 of the upper hinge bracket 40 is not secured against the upper elongate bracket 32 by the plurality of fasteners 78. The upper hinge bracket 40 may be removed from the third mounting location 64 when the engagement assembly 74 is in the disengaged position 82 and when none of the plurality of engagement features 76 are received by one of the plurality of fasteners 78. Additional engagement assemblies 74 included on the door 22 may also be operable between the engaged position 80 and the disengaged position 82.

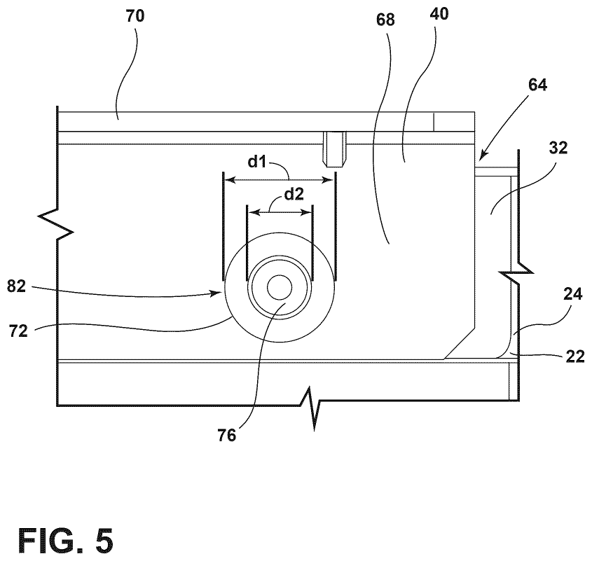

With reference to FIGS. 4B and 5, each of the plurality of apertures 72 of the upper hinge bracket 40 defines a first diameter d1, and each of the plurality of engagement features 76 at the third mounting location 64 defines a second diameter d2, where the first diameter d1 is significantly greater than the second diameter d2. As a result, the plurality of apertures 72 is translatable relative to the plurality of engagement features 76 when the engagement assembly 74 is in the disengaged position 82. Accordingly, in the disengaged position 82, the upper hinge bracket 40 is slidable relative to the third mounting location 64 in at least a first dimension 84 and a second dimension 86, thereby enabling adjustment of the door 22 relative to the cabinet 12 (FIG. 1). It is contemplated that the plurality of apertures 72 of the upper hinge bracket 42 may have different diameters, and the plurality of engagement features 76 at the third mounting location 64 may also have different diameters. Furthermore, the plurality of apertures 72 of the lower hinge bracket 42 (FIG. 3) may have an identical or similar relationship with respect to an additional engagement assembly 74 at one of the plurality of mounting locations defined by the lower elongate bracket 34.

In one exemplary assembly process of the refrigerator 10, alignment blocks and/or fixtures may be used to maintain an optimal distance between the door 22 and the cabinet 12. For example, when the engagement assembly 74 at the third mounting location 64 and an additional engagement assembly 74 at the fourth mounting location 66 are in the disengaged position 82, the door 22 may be aligned with the cabinet 12 using alignment blocks, and the upper and lower hinge brackets 40, 42 may be disposed at the third and fourth mounting locations 64, 66, respectively. The upper and lower hinge brackets 40, 42 may then be adjusted in the first and/or second dimensions 84, 86 and coupled to the upper and lower hinges 18, 20, respectively. Thereafter, the engagement assembly 74 may then be operated from the disengaged position 82 to the engaged position 80, thereby tuning the alignment between the door 22 and the cabinet 12. Thereafter, the gasket 52 may be added to the door 22 such that the gasket 52 may form an optimal seal with the front face 46 of the cabinet 12.

With reference to FIGS. 3 and 4B, the upper hinge bracket 40 is translatable along the top side 24 of the door 22 in the first dimension 84 and transverse to the top side 24 of the door 22 when the engagement assembly 74 is in the disengaged position 82. Furthermore, the upper hinge bracket 40 is translatable in any direction on a plane defined by the third mounting location 64, including directions that are parallel and orthogonal to the top side 24 of the door 22. It is contemplated that the upper hinge bracket 40 may alternatively be translatable in any direction on a plane defined by a different mounting location to which the upper hinge bracket 40 is coupled. When the engagement assembly 74 is in the engaged position 80, the upper hinge bracket 40 is not translatable in either the first dimension 84 or the second dimension 86 due to the resistance created by the compression of the upper hinge bracket 40 between the plurality of fasteners 78 and the upper elongate bracket 32. In some instances, the upper hinge bracket 40 may be pivotal relative to the third mounting location 64 or another mounting location. It is contemplated that the upper hinge bracket 40 may also be pivotal and/or translatable in a third dimension. As compared to the upper hinge bracket 40, the lower hinge bracket 42 may also be identically or similarly translatable and/or rotatable about one of the plurality of mounting locations defined by the upper and lower elongate brackets 32, 34.

The hinge bracket assembly 8 shown and described herein is advantageous compared to known refrigerator hinge bracket systems. For example, the upper and lower hinge brackets 40, 42 are configured to be coupled to a variety of mounting locations proximate the top and bottom sides 24, 26 of the door 22, which provides an enhanced degree of adjustability when aligning the door 22 and the cabinet 12. Such adjustability may be achieved with only two hinge brackets as opposed to four hinge brackets. Furthermore, the upper and lower hinge brackets 40, 42 provide minimal contact areas for contact with the upper and lower hinges 18, 20, which require minimal padding and concealment. For example, the upper and lower hinge brackets 40, 42 may be overlaid with two smaller hinge covers as compared to previous designs that include an elongate hinge cover extending along each of the top and bottom sides 24, 26 of the door 22 to cover larger hinge brackets. Protective brackets and/or packaging material may also be minimized during shipment of the refrigerator 10 equipped with the hinge bracket assembly 8, as the door 22 may be adequately supported during shipping at the one or more mounting locations of the top and bottom sides 24, 26 at which the upper and lower hinge brackets 40, 42 are not coupled. Thus, the risk of damage of the upper and lower hinge brackets 40, 42, and/or other components of the door 22, can be decreased.

It will be understood by one having ordinary skill in the art that construction of the described disclosure and other components is not limited to any specific material. Other exemplary embodiments of the disclosure disclosed herein may be formed from a wide variety of materials, unless described otherwise herein.

According to one aspect of the present disclosure, a refrigerator includes a cabinet defining an upper side and a lower side, an upper hinge coupled to the cabinet proximate the upper side, a lower hinge coupled to the cabinet proximate the lower side, and a door defining a top side, a bottom side, a first side, and a second side, wherein the first side and the second side extend between the top side and the bottom side of the door. An upper elongate bracket extends along the top side of the door and a lower elongate bracket extending along the bottom side of the door, wherein the upper elongate bracket and the lower elongate bracket each define a plurality of mounting locations, wherein the plurality of mounting locations of the upper elongate bracket defines a first mounting location, and wherein the plurality of mounting locations of the lower elongate bracket defines a second mounting location. An upper hinge bracket is coupled to the upper hinge and the first mounting location, wherein the upper hinge bracket is adjustable relative to the upper elongate bracket in at least two dimensions, and a lower hinge bracket is coupled to the lower hinge and the second mounting location, wherein the lower hinge bracket is adjustable relative to the lower elongate bracket in the at least two dimensions.

According to another aspect of the present disclosure, the first mounting location is proximate the first side of the door and the second mounting location is proximate the first side of the door.

According to yet another aspect of the present disclosure, the upper hinge bracket is mountable to any of the plurality of mounting locations of the upper elongate bracket, and the lower hinge bracket is mountable to any of the plurality of mounting locations of the lower elongate bracket.

According to still yet another aspect of the present disclosure, the upper hinge bracket is mountable to any of the plurality of mounting locations of the lower elongate bracket, and the lower hinge bracket is mountable to any of the plurality of mounting locations of the upper elongate bracket.

According to yet another aspect of the present disclosure, the refrigerator includes a first engagement assembly configured to couple the upper hinge bracket to the first mounting location and a second engagement assembly configured to couple the lower hinge bracket to the second mounting location, wherein the first engagement assembly and the second engagement assembly are operable from a disengaged position to an engaged position.

According to another aspect of the present disclosure, each of the upper hinge bracket and the lower hinge bracket is adjustable relative to the upper elongate bracket and the lower elongate bracket, respectively, when the first engagement assembly and the second engagement assembly are in the disengaged position, and each of the upper hinge bracket and the lower hinge bracket is fixedly coupled to the first mounting location and the second mounting location, respectively, when the first engagement assembly and the second engagement assembly are in the engaged position.

According to yet another aspect of the present disclosure, each of the upper hinge bracket and the lower hinge bracket defines an aperture, wherein the first engagement assembly includes a first engagement feature and the second engagement assembly includes a second engagement feature, and wherein the first engagement feature and the second engagement feature extend through the apertures of the upper hinge bracket and the lower hinge bracket, respectively.

According to still yet another aspect of the present disclosure, each of the apertures of the upper hinge bracket and the lower hinge bracket defines a first diameter, and each of the first engagement feature and the second engagement feature has a second diameter that is smaller than the first diameter of the apertures of the upper hinge bracket and the lower hinge bracket, respectively, thereby enabling adjustment of the upper hinge bracket and the lower hinge bracket relative to the upper elongate bracket and the lower elongate bracket, respectively, in the at least two dimensions.

According to yet another aspect of the present disclosure, the first engagement feature extends from the upper elongate bracket, and the second engagement feature extends from the lower elongate bracket.

According to another aspect of the present disclosure, a hinge bracket assembly for an insulated appliance includes a door defining a top side, a bottom side, a first side, and a second side, wherein the first side and the second side extend between the top side and the bottom side. A plurality of mounting locations is provided proximate each of the top side and the bottom side, the plurality of mounting locations including a first mounting location proximate the top side. A first hinge bracket is adjustably coupled to the first mounting location, wherein the first hinge bracket is configured to adjustably couple to each of the plurality of mounting locations, and wherein the first hinge bracket is adjustable relative to the first mounting location in at least two dimensions.

According to yet another aspect of the present disclosure, the first hinge bracket defines a first aperture, and the first aperture receives a first engagement feature.

According to still yet another aspect of the present disclosure, the first aperture defines a first diameter, and the first engagement feature has a second diameter that is significantly smaller than the first diameter.

According to yet another aspect of the present disclosure, the first hinge bracket defines a second aperture, and the second aperture receives a second engagement feature.

According to another aspect of the present disclosure, the second aperture defines a third diameter, and the second engagement feature has a fourth diameter that is significantly smaller than the third diameter.

According to yet another aspect of the present disclosure, the first hinge bracket is translatable relative to the first mounting location in any direction along a plane defined by the first mounting location.

According to still yet another aspect of the present disclosure, the hinge bracket assembly includes a second hinge bracket configured to adjustably couple to each of the plurality of mounting locations, wherein the second hinge bracket is adjustable relative to a second mounting location of the plurality of mounting locations in at least two dimensions.

According to yet another aspect of the present disclosure, a hinge bracket assembly includes an upper hinge bracket coupled to an upper hinge of an appliance and a first mounting location proximate a top side of an insulated door, wherein the upper hinge bracket is adjustable relative to the insulated door, and a lower hinge bracket coupled to a lower hinge of the appliance and a second mounting location proximate a bottom side of the insulated door, wherein the lower hinge bracket is adjustable relative to the insulated door, wherein the upper hinge bracket is configured to couple to the lower hinge and the second mounting location, and wherein the lower hinge bracket is configured to couple to the upper hinge and the first mounting location.

According to another aspect of the present disclosure, the upper hinge bracket and the lower hinge bracket are translatable in a first dimension along the top side and the bottom side of the insulated door, respectively.

According to yet another aspect of the present disclosure, the upper hinge bracket and the lower hinge bracket are translatable in a second dimension.

According to still yet another aspect of the present disclosure, the hinge bracket assembly includes a third mounting location proximate the top side of the insulated door, wherein the upper hinge bracket is configured to couple to the third mounting location, and a fourth mounting location proximate the bottom side of the insulated door, wherein the lower hinge bracket is configured to couple to the fourth mounting location.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A refrigerator, comprising:
a cabinet defining an upper side and a lower side;
an upper hinge coupled to the cabinet proximate the upper side;
a lower hinge coupled to the cabinet proximate the lower side;
a door defining a top side, a bottom side, a first side, and a second side, wherein the first side and the second side extend between the top side and the bottom side of the door;
an upper elongate bracket extending along the top side of the door and a lower elongate bracket extending along the bottom side of the door, wherein the upper elongate bracket and the lower elongate bracket each define a plurality of mounting locations, wherein the plurality of mounting locations of the upper elongate bracket includes a first mounting location, and wherein the plurality of mounting locations of the lower elongate bracket includes a second mounting location;
an upper hinge bracket coupled to the upper hinge and the first mounting location, wherein the upper hinge bracket is adjustable relative to the upper elongate bracket in at least two dimensions; and
a lower hinge bracket coupled to the lower hinge and the second mounting location, wherein the lower hinge bracket is adjustable relative to the lower elongate bracket in at least two dimensions.

2. The refrigerator of claim 1, wherein the first mounting location is proximate the first side of the door and the second mounting location is proximate the first side of the door.

3. The refrigerator of claim 2, wherein the upper hinge bracket is mountable to any of the plurality of mounting locations of the upper elongate bracket, and wherein the lower hinge bracket is mountable to any of the plurality of mounting locations of the lower elongate bracket.

4. The refrigerator of claim 3, wherein the upper hinge bracket is mountable to any of the plurality of mounting locations of the lower elongate bracket, and wherein the lower hinge bracket is mountable to any of the plurality of mounting locations of the upper elongate bracket.

5. The refrigerator of claim 4, further including:
a first engagement assembly configured to couple the upper hinge bracket to the first mounting location; and
a second engagement assembly configured to couple the lower hinge bracket to the second mounting location, wherein the first engagement assembly and the second engagement assembly are operable from a disengaged position to an engaged position.

6. The refrigerator of claim 5, wherein each of the upper hinge bracket and the lower hinge bracket is adjustable relative to the upper elongate bracket and the lower elongate bracket, respectively, when the first engagement assembly and the second engagement assembly are in the disengaged position, and wherein each of the upper hinge bracket and the lower hinge bracket is fixedly coupled to the first mounting location and the second mounting location, respectively, when the first engagement assembly and the second engagement assembly are in the engaged position.

7. The refrigerator of claim 6, wherein each of the upper hinge bracket and the lower hinge bracket defines an aperture, wherein the first engagement assembly includes a first engagement feature and the second engagement assembly includes a second engagement feature, and wherein the first engagement feature and the second engagement feature extend through the apertures of the upper hinge bracket and the lower hinge bracket, respectively.

8. The refrigerator of claim 7, wherein each of the apertures of the upper hinge bracket and the lower hinge bracket defines a first diameter, and wherein each of the first engagement feature and the second engagement feature has a second diameter that is smaller than the first diameter of the apertures of the upper hinge bracket and the lower hinge bracket, respectively, thereby enabling adjustment of the upper hinge bracket and the lower hinge bracket relative to the upper elongate bracket and the lower elongate bracket, respectively, in at least two dimensions.

9. The refrigerator of claim 8, wherein the first engagement feature extends from the upper elongate bracket, and wherein the second engagement feature extends from the lower elongate bracket.

10. A hinge bracket assembly for an insulated appliance, comprising:
a door defining a top side, a bottom side, a first side, and a second side, wherein the first side and the second side extend between the top side and the bottom side;
a plurality of mounting locations provided proximate each of the top side and the bottom side, the plurality of mounting locations including a first mounting location proximate the top side; and
a first hinge bracket adjustably coupled to the first mounting location, wherein the first hinge bracket is configured to be adjustably coupled to each of the plurality of mounting locations, and wherein the first hinge bracket is adjustable relative to the first mounting location in at least two dimensions.

11. The hinge bracket assembly of claim 10, wherein the first hinge bracket defines a first aperture, and wherein the first aperture receives a first engagement feature.

12. The hinge bracket assembly of claim 11, wherein the first aperture defines a first diameter, and wherein the first engagement feature has a second diameter that is significantly smaller than the first diameter.

13. The hinge bracket assembly of claim 12, wherein the first hinge bracket defines a second aperture, and wherein the second aperture receives a second engagement feature.

14. The hinge bracket assembly of claim 13, wherein the second aperture defines a third diameter, and wherein the second engagement feature has a fourth diameter that is significantly smaller than the third diameter.

15. The hinge bracket assembly of claim 14, wherein the first hinge bracket is translatable relative to the first mounting location in any direction along a plane defined by the first mounting location.

16. The hinge bracket assembly of claim 10, further comprising:
a second hinge bracket configured to be adjustably coupled to each of the plurality of mounting locations, wherein the second hinge bracket is adjustable relative to a second mounting location of the plurality of mounting locations in at least two dimensions.

17. A hinge bracket assembly, comprising:
an upper hinge bracket coupled to an upper hinge of an appliance and a first mounting location proximate a top side of an insulated door, wherein the upper hinge bracket is adjustable along and transversely to the top side of the insulated door; and
a lower hinge bracket coupled to a lower hinge of the appliance and a second mounting location proximate a bottom side of the insulated door, wherein the lower hinge bracket is adjustable along and transversely to the top side of the insulated door, wherein the upper hinge bracket is configured to be coupled to the lower hinge and the second mounting location, and wherein the lower hinge bracket is configured to be coupled to the upper hinge and the first mounting location.

18. The hinge bracket assembly of claim 17, further comprising:
a third mounting location proximate the top side of the insulated door, wherein the upper hinge bracket is configured to be adjustably coupled to the third mounting location.

19. The hinge bracket assembly of claim 18, further comprising:
a fourth mounting location proximate the bottom side of the insulated door, wherein the lower hinge bracket is configured to be adjustably coupled to the fourth mounting location.

20. The hinge bracket assembly of claim 18, wherein the upper hinge bracket is configured to be adjustably coupled to the fourth mounting location, and wherein the lower hinge bracket is configured to be adjustably coupled to the third mounting location.
